(19) United States
(12) Patent Application Publication
(10) Pub. No.: US 2001/0037972 A1
(43) Pub. Date: Nov. 8, 2001

(54) Fluid separating device

(76) Inventors: Nathaniel R. Quick, Lake Mary, FL (US); Alexander Sobolevsky, Deland, FL (US); Michael Liberman, Deland, FL (US); Michael C. Murray, Eustis, FL (US); Richard D. Range JR., Deland, FL (US)

Correspondence Address: FRIJOUF, RUST & PYLE, P.A., 201 East Davis Boulevard, Tampa, FL, 33606, US

(21) Appl. No.: 09/825,459

(22) Filed: Apr. 3, 2001

Related U.S. Application Data
(60) Provisional application No. 60/194,376, filed on Apr. 4, 2000.

(51) Int. Cl. B01D 69/08

(52) U.S. Cl. 210/491; 210/505; 210/500.23; 210/500.25

(57) ABSTRACT

An improved fluid separating device for filtering a second fluid from a first fluid. The improved fluid separating device comprises a first layer of filter media comprising a sintered matrix of first fibers. A second layer of filter membrane comprises a matrix of second fibers. A third layer of filter media comprises a sintered matrix of third fibers. The first, second and third layers are formed into a lamination with the second layer being interposed between the first and third layers. The second layer has a pore size substantially less than the pore size of the first and third layers for enabling the second fluid to pass through the second layer and for inhibiting the first fluid from passing through the second layer for separating the second fluid from the first fluid. The improved fluid separating device is suitable for separating a gas from a liquid as well as separating a gas from a dissimilar gas.

### CROSS-REFERENCE TO RELATED APPLICATIONS

This application claims benefit of U.S. Patent Provisional application Ser. No. 60/194,376 filed Apr. 4, 2000. All subject matter set forth in provisional application Ser. No. 60/194,376 is hereby incorporated by reference into the present application as if fully set forth herein.

### BACKGROUND OF THE INVENTION

1. Field Of The Invention

This invention relates to filtration and to separation and more particularly to an improved fluid separating device suitable for separating a gas from a liquid as well as separating a gas from a dissimilar gas.

2. Background Of Related Art

Metallic fibers have been used for a wide variety of applications by the prior art. Typically, metallic fibers have been used for high-pressure and high temperature applications. These high pressure and high temperature applications include high-pressure and high temperature filtration of liquids especially high temperature viscous liquids such as moltent polymers and the like.

The following United States patents illustrate prior art patents representative of the various uses of metallic fibers as well as being representative of filtration in general.

U.S. Pat. No. 3,262,815 to Langer et al. discloses an electrode suitable for a secondary battery comprising a plate formed from a compact body of intermingled fine metal fibers, the majority of the fibers extending the full height of the plate and a small proportion extending transverse thereto. The fine metal fibers have a generally parallel linear orientation in one direction and an active electrode material is distributed on and disposed within the body of the metal fibers. A liquid electrolyte permeable sheet wrapping encloses the plate. An electrical contact is attached to the plate transverse to the general linear orientation of the fine metal fibers whereby most of the fibers are directly connected thereto. An electrical lead is attached to the electrical contact and an insulated covering is disposed about the lead and the contact.

U.S. Pat. No. 3,977,847 to Clark discloses a particle laden gas stream being cleaned by passing it through an all metal fabric including a base with pile fibers connected to the base. The flowing gas forces the pile fibers to lie down upon each other to form a depth filter media adapted to entrap fine particles. This depth filter media is cleaned to remove entrapped particles by passing air through the fabric in a direction counter to the direction the particle laden gas flows through the fabric. Consequently, the pile fibers tend to open and extend outwardly from the base, permitting entrapped particles to be carried by the air from the fabric. An apparatus including a tubular element made of an all metal pile fabric is also disclosed. The tubular element has associated with it one or more nozzles adapted to blow air through the fabric along an incremental portion of the tubular element. Consequently, a small portion of the fabric is cleaned while simultaneously the remainder of the fabric filters particles from the gas stream.

U.S. Pat. No. 3,986,530 to Maekawa discloses a knitted or woven cloth having antistatic properties which is suitable for use in the preparation of filter bags and garments. The cloth contains an electrically conductive thread composed of 10 to 90 weight % of electroless metal plated staple fibers, and 9 to 10 weight % of metallic filaments, in an amount of 0.1 to 1.0 thread per cm width of the cloth.

U.S. Pat. No. 3,994,810 to Schaeffer discloses a filtering device that comprises a plurality of parallel filter elements with means within the device for backflushing two or more of the filter elements without removing the elements from the device and while the device is being operated onstream and filtering. The backflushed fluid used to clean the elements is isolated from the primary fluid stream and discharged from the device.

U.S. Pat. No. 4,053,290 to Chen et al. discloses vertically disposed fiber bed elements and separators containing the same wherein “bubble re-entrainment” of a collected liquid phase in a gas stream flowing through the fiber bed is substantially eliminated or reduced. “Bubble re-entrainment” refers to that re-entrainment of liquid which occurs at the bottom of the fiber bed where the cumulative drainage of the liquid is at its maximum. This is accomplished by providing at the bottom of the fiber bed a vertically disposed gas flow baffle means such as, e.g., a baffle plate, such that some portion of the fiber bed is disposed downstream of the baffle means and shielded by the lee side of said baffle means from the moving gas stream, said shielding being effective throughout the shielded portion of the fiber bed to reduce the bed velocity of any gas flowing therethrough to below a bubble re-entraining velocity. In a preferred embodiment, the fiber bed is a bicomponent bed of two fiber beds, the first or upstream bed being of at least 5 micron mean diameter fibers, the second or downstream bed being of somewhat coarser fibers than, in intimate contact with, the first bed, and the baffle means being disposed at the interface between the two beds.

U.S. Pat. No. 4,122,015 to Oda et al. discloses a fortified metal filter possessing a high filtering efficiency, a large pore ratio and a wide net area of fused parts of fine stainless steel wires prepared by crushing the edges of these wires. The wires utilized in the system are composed of numerous polygonally cross-sectioned fine stainless steel wires. The procedure for preparing such filters, in which only the fused part, which arises from the crushing of the wire edges, possesses a large net area and the metal is diffused into the fused part, is achieved by heating and compressing the system simultaneously.

U.S. Pat. No. 4,126,560 to Marcus et al. discloses a filter medium for removing contaminants, including gels, from molten polymers. The medium contains layers of sintered metal fibers having diameters of 50 microns or less. At least two adjacent layers are separated by a screen, and the screen and layers are bonded together by compression and sintering. Preferably the layers include from 35 to 60 volume percent fibers. The filter medium is graded so that the polymer as it flows through the medium encounters fiber layers having pores that generally decrease in size. The screen has pores that are larger than the average size of the pores in any downstream layer and that are larger than the average size of the pores in the upstream layer immediately adjacent the screen. The screen collects at least some of the gels or other particles that pass through the upstream layer, giving the medium a higher dirt holding capacity than the conventional filter medium.

U.S. Pat. No. 4,136,894 to Ona et al. discloses a gas generator for inflatable vehicle safety bags comprising a housing defining three independent chambers each containing a charge of gas generating agent in a sealed wrapper surrounding an electrical ignition squib. Layers of heat absorbing wire gauze, a porous plate, and sintered filter sheets overlie the charge. The open top of each chamber is covered by an apertured diffuser. An apertured deflector plate is secured to the housing above the diffusers. Generated gases passing through the apertures in the deflector plate inflate a relatively small inner knee bag. Laterally diverted gases inflate a larger outer torso bag surrounding the knee bag. The inflation impact may be minimized by delaying the ignition of one or more chambers relative to the other(s), and by igniting only selected chambers in response to low speed collisions.

U.S. Pat. No. 4,169,059 to Storms discloses an autogenous or sinter bond between metallic filter media and other metal components of a filter assembly. The sinter bond is produced by joining the parts through a diffusion bonding membrane. The membrane comprises a web of small diameter metal fibrils which will sinter bond to both the filter media and the other filter parts to form a physically strong and leak-free seal.

U.S. Pat. No. 4,181,514 to Lefkowitz et al. discloses a dimensionally stable filter structure for high temperature applications and method of making it. The filter structure comprises at least one batt of relatively brittle fibers, known to possess outstanding degredation resistance at elevated temperatures, stitch-knitted with high temperature and corrosion resistant yarns.

U.S. Pat. No. 4,206,271 to Norling et al. discloses a method for the manufacture of a highly porous nickel electrode body for electrical accumulators. The new electrode body is also disclosed. By using 5-7% volume of a nickel powder in admixture with 93-95% by volume of a pore-forming agent selected from the group consisting of ammonium bicarbonate and ammonium carbonate when pressing and sintering the electrode body a very high porosity is obtained, such as 90-95%, in spite of which the mechanical strength of the body is so high as to resist the strains of an accumulator cell. Especially preferable to impart outstanding strength to the electrode body, is a pressure of at least 100 MPa in the pressing operation.

U.S. Pat. No. 4,251,238 to Claes et al. discloses a method and apparatus for demisting gases wherein a stream of gas containing submicron liquid particles is caused to pass through a filter material comprising at least in part a material having a porosity of at least 0.985.

U.S. Pat. No. 4,251,603 to Matsumoto et al. discloses a battery electrode comprising a plaque made of a sponge-like porous metal matrix having a multiplicity of cells connected with each other in three-dimensions. The sectional area of the gratings making up the sponge-like metal porous plaque decreases continuously along the thickness of the plaque from the surface toward the central part and an active material is impregnated in the porous plaque.

U.S. Pat. No. 4,265,703 to Terliska discloses that this invention relates to a fibrous structure containing metallic fibers. The fibrous structure is characterized in that the fibers which constitute said fibrous structure have been deposited by wet process. The metallic fibers which the fibrous structure contains possess at their surface traces of a hydrosoluble binder, which has served initially for coating the metallic fibers. This invention relates also to the method of preparing the fibrous structure and also to its application, notably in the production of security papers, metallic filtering elements and elements for protection against electromagnetic waves.

U.S. Pat. No. 4,488,966 to Schaeffer discloses that this invention comprehends a new and unique means for preventing the crowns (forward projections of the pleats) of a backflushable filter element from splitting due to the cyclic action that is experienced during cleaning and backflushing. In one embodiment, a plurality of spacers, preferably wedge shape, are positioned between the outwardly projecting pleats of the filter media thereby preventing the splitting thereof. A plurality of spacers may also be placed between the inwardly projecting pleats to provide additional support during the cleaning and backflushing cycle. In another embodiment a ring is placed adjacent the inwardly directed pleats and the inner end cap lip; this also prevents splitting of the crowns when the filter element is subjected to the cyclic action of cleaning and backflushing.

U.S. Pat. No. 4,628,593 to Fritts et al. discloses a low shear battery plaque and a nickel electrode fabricated therefrom, the latter consisting essentially of a centrally located layer of a conductive felt, layers of sintered nickel on each side of the felt and nickel hydroxide active material disposed throughout the pores of the sintered nickel.

U.S. Pat. No. 4,687,579 to Bergman discloses that a particulate filter medium is formed of a sintered composite of 0.5 micron diameter quartz fibers and 2 micron diameter stainless steel fibers. A preferred composition is about 40 vol. % quartz and about 60 vol. % stainless steel fibers. The media is sintered at about 1100 degree C to bond the stainless steel fibers into a cage network which holds the quartz fibers. High filter efficiency and low flow resistance are provided by the smaller quartz fibers. High strength is provided by the stainless steel fibers. The resulting media has a high efficiency and low pressure drop similar to the standard HEPA media, with tensile strength at least four times greater, and a maximum operating temperature of about 550 degrees C. The invention also includes methods to form the composite media and a HEPA filter utilizing the composite media. The filter media can be used to filter particles in both liquids and gases.

U.S. Pat. No. 4,889,630 to Reinhardt et al. discloses a self-supporting composite filter for ultra filtration that can be backwashed and has a central porous body which supports a thin diaphragm of fine porosity applied to the outer surface of the body. The body is porous, being formed by coarse grains and a binder. The diaphragm is thin in comparison to the filter body and is formed from a mix of fine grains, fibers and binder whose percentage composition, by volume, is in the ratio 60 to 40:40 to 20:30 to 10. The fibers are thin, 0.3 to 30 microns, and long, with a length at least 10 times their width to provide a microelasticity in the diaphragm. The absolute thickness of the diaphragm is 0.2 to 2 millimeters which is 5 to 75 times smaller than that of the support body. The ratio of the specific permeabilities of the support body to that of the diaphragm, for fluids in the laminar flow range, is between 2:1 and 100:1.

U.S. Pat. No. 4,915,714 to Teague et al. discloses a fiber bed element and process for utilizing such element for removing and collecting small particles of liquids or soluble solids from a gas stream, the element formed of one or more layers of pin-punched fiber supported by an appropriate supporting structure, the fiber layers being subjected to pressure to achieve a selected density and the punched holes functioning to create drainage paths through which liquids may drain. The fiber layer density and fiber size is maintained uniform throughout the element so that the pressure drop of the saturated filter bed element will be between 1.1 and 3.0 times the pressure drop of the dry filter bed as originally constructed and before use.

U.S. Pat. No. 5,080,963 to Tatarchuk et al. discloses a new class of composite results from a matrix of carbon fibers, including graphite fibers, interwoven in a network of fused metal fibers. The composites can be fabricated to have varying surface area, void volume and pore size while maintaining high electrical conductivity. Composites are readily prepared from a preform of a dispersion of carbon fibers, metal fibers, and an organic binder such as cellulose, by heating the preform at a temperature sufficient to fuse the metal fibers and to volatilize at least 90% of the binder with a loss of less than about 25%, and usually under 10%, by weight of carbon fiber.

U.S. Pat. No. 5,106,707 to Catotti et al. discloses a sealed rechargeable nickel electrode containing an electrochemical cell having a pasted negative electrode with paste layers adhered to a nonforminous conductive substrate, which retards growth (swelling) of the nickel electrode on cycling.

U.S. Pat. No. 5,200,281 to Leap et al. discloses a sintered bipolar battery plate which is made containing two porous electrodes and a central, non-porous, metallic cell separator-current collector sheet. The positive electrode contains sintered particles of elemental silver sintered into an expanded metal sheet and the negative electrode contains sintered particles of elemental iron sintered into an expanded metal sheet. The positive and negative electrodes are sintered to a thin, porous, metallic connection layer selected from at least one of nickel fiber or nickel powder, which is sintered to the current collector. This plate can be placed in a case containing alkali hydroxide electrolyte and having metal end plates for electrical connections.

U.S. Pat. No. 5,200,282 to Masuhiro et al. discloses a nickel electrode for use in an alkaline battery using a network-like alkaline-proof metal mesh having pores at the inside thereof as a core metal current collector, as well as an alkaline battery using such a nickel electrode. Inexpensive nickel electrode having high performance, great capacity can be obtained at high productivity.

U.S. Pat. No. 5,244,758 to Bronoel et al. discloses a positive nickel electrode having a structure of cellular nickel foam filled with a paste based on nickel hydroxide. The paste contains (in dry matter and per 100 parts by weight nickel hydroxide) 7 to 8 parts by weight powder-form nickel metal, 5 to 12 parts by weight of a cobalt hydroxide and/or salt, the parts by weight being expressed as equivalents of cobalt metal.

U.S. Pat. No. 5,300,234 to Oechsle et al. discloses a method of filtering beverages and other liquids. To avoid the considerable ecoproblems encountered with the filter aids of known procedures, which must be thrown away, the filtering active structure of the inventive filter aids is maintained so that they may be reused as often as required. A mixture of filter aids of varying morphological and physical components is used, and constitutes a minimum of two components. The components comprise one component of specifically heavy, chemically stable metal and/or metal oxide and/or carbon particles of fibrous and/or granular structure, and a further component, for building up the filter cake and increasing its volume, of synthetic and/or cellulose fibers having a fiber length of 1 to 5000 um and a fiber thickness of 0.5 to 100 um. To increase the filtering efficiency of the filter cake of the aforementioned components, a further component may 20 be added that comprises fibrillated or fanned out synthetic and/or cellulose fibers, preferably having a fiber length of 500 to 5000 um and a fiber thickness of 0.5 to 20 um. The components are intensively mixed to form a homogeneous mixture, and are dosed to the liquid that is to be filtered.

U.S. Pat. No. 5,484,620 to Oechsle et al. discloses that with the method of processing liquids, fine to very fine organic and/or inorganic granular particles are used, whereby pursuant to the invention the particles are mixed and compressed together in a first step to form an agglomerate that is heated at least to a temperature that is near the melting point thereof. The particles are thereby fixed in place by being subjected to a process similar to sintering for a suitable length of time, whereupon the resulting agglomerate is screened, or reduced in size in a grinder, to a granular size that is suitable for an intended use. This enables stabilizing and filtering aids to be produced with predetermined or predictable physical or chemical properties that are suitable for specific processes.

U.S. Pat. No. 5,486,220 to Honda et al. discloses an exhaust gas purification filter comprising a metal porous body obtained by packing and fixing metal fibers having a mean fiber diameter of 5 to 40 um or heat resistant ceramic fibers having a mean fiber diameter of 1 to 40 um in a dispersed state into pores of a foamed structure porous body made of a heat-resistant metal so that a packing density of the resulting metal porous body is from 5 to 20%. The filter may be in a laminated structure by laminating the foregoing foamed structure porous body filled with or without the metal or ceramic fibers and a fiber structure porous body obtained by fixing metal fibers having a mean diameter of 5 to 40 um or heat-resistant ceramic fibers having a mean diameter of 1 to 40 um in a dispersed state so that a packing density is from 5 to 25% are laminated. By using the inventive filter for collecting PM (dry soot, fine particles and SOF) contained in an exhaust gas of a Diesel engine, a pressure loss for the exhaust gas is minimized while high collection efficiency is kept.

U.S. Pat. No. 5,492,623 to Ishibe discloses a laminated filter material for removing foreign materials from gas or liquid with high precision. The fabricating method and a filter using a laminated filter material are described. The laminated filter material comprises a support member of porous metal and a particle layer of fine particles laminated on a surface having asperities of the support member, by immersing the support member in a suspension of the particles without a binder, and evacuating the suspension through the support member. The method for fabricating includes the steps of preparing a suspension of particles finer than the average pore diameter of support member without using a binder, immersing the support member, and evacuating the suspension through the support member. The filter has a housing for supporting the laminated filter material, wherein the housing is provided with a metal attachment part having a surface contacting an end-face of the laminated filter material, and the attachment part and end-face of the laminated filter material are fixed by fusing the particle layer from the reverse side of the contacting surface of the attachment part.

U.S. Pat. No. 5,501,275 to Card et al. discloses that the addition of fibrous mixtures in intimate mixtures with particulates for fracturing and gravel packing decreases or eliminates the undesirable flowback of proppant or formation fines while stabilizing the sand pack and lowering the demand for high polymer loadings in the placement fluids. Fibers are useful for forming a porous pack in the subterranean formation. In some cases, channels or fingers of void spaces with reduced concentrations of proppant may be introduced into the proppant pack.

U.S. Pat. No. 5,505,757 to Ishii discloses a metal filter for a particulate trap which meets the requirements for low pressure drop, high collecting capacity and a long life. The metal filters have one or more layers of unwoven fabric (such as felt) formed of a metal fiber having one of the following alloy compositions A, B and C wherein composition A is made of Ni: 5-20% by weight, Cr: 10-40 by weight, Al: 1-15% by weight, the remainder being Fe and inevitable impurities; composition B is made of Cr: 10-40% by weight, Al: 1-15% by weight, the remainder being Ni and inevitable impurities; and composition C is made of Cr: 10-40% by weight, Al: 1-15% by weight, the remainder being Fe and inevitable components. The metal filter is highly resistant to corrosion and heat and can withstand repeated heatings for removal of the particulate.

U.S. Pat. No. 5,525,423 to Liberman et al. discloses an apparatus and method for an improved fiber tow having plural diameter metallic wires, comprising the drawing of a first cladded metallic wire to provide a first drawn cladding of reduced diameter. The first cladding is separated into a primary portion and a secondary portion with the secondary portion being drawn to reduce further the diameter. A selected mixture of the primary and the secondary portions are cladded to provide a secondary cladding. A plurality of the second drawn claddings is cladded and drawn to provide a third cladding of reduced diameter. The third cladding is drawn and the claddings are removed to provide a fiber tow comprising metallic wires having a major diameter and a minor diameter. The fiber tow may be severed into uniform length to provide slivers of metallic wires having plural diameters. The plural diameter slivers may be used for various purposes including a filter medium or may be encapsulated within polymeric material for providing an electrically conductive metallic layer therein.

U.S. Pat. No. 5,560,757 to Suzuki et al. discloses an exhaust particulate filter for a diesel engine which is high in collecting efficiency of exhaust particulates and small in pressure loss, by using a felt-like body having pores of an optimum inner diameter between heat resistant inorganic lengthy fibers. Wire nets formed of heat resistant metal are put upon both upper and lower surfaces of felt-like body, which are arrested from both the surfaces thereof by heat resistant yarn. The felt-like body is configured such that heat resistant inorganic lengthy fibers cut into a predetermined length are irregularly oriented in a horizontal direction and laminated, to which needles are applied, and the inorganic lengthy fibers are vertically entangled.

U.S. Pat. No. 5,582,867 to Tsubouchi et al. discloses that in manufacturing a corrosion-resistant metallic porous member having high Cr content by diffusion process in which the material is heat-treated, a plurality of heat cycles are used to achieve uniform Cr content in the thickness direction. Metallic porous body of Ni, Fe, Ni—Cr or Fe—Cr is buried in a powder of Al, Cr and NH₄Cl. Inert gas such as Ar and H₂ is introduced and the porous body is heat treated at 800 degree-1100 degree C. In the heat treatment, at least two temperature-increase and temperature-decrease steps are included.

U.S. Pat. No. 5,611,832 to Suzuki et al. discloses that according to the present invention, a filter body for collecting particulates is constituted of a fiber laminate material produced by laminating a fiber material comprising a core material in the form of a fiber, and a covering layer of a material different from that of the core material formed around the outer periphery of the core material by coating. The core material of the fiber material is selected from among inorganic fibers such as glass or ceramic fibers containing alumina, and heat-resistant alloy fibers each made of a heat-resistant alloy selected from among Ti—Al alloys, Fe alloys containing at least one of Mo, Cr and Ni, and Fe—Cr—Al—Y alloys. The covering layer is made of a material selected from among silicon carbide ceramics respectively derived from polytitanocarbosilane, polysilazane and polycarbosilane, thermoplastic materials, silicon carbide ceramics such as Si—C, Si—Ti—C—O and Si—C—O or silicon nitride ceramics such as Si—N—C—O, alumina ceramics, and zirconia ceramics.

U.S. Pat. No. 5,637,544 to Shadman discloses a reactive membrane for removing impurities, such as water, oxygen and organic compounds, from a gas is provided. The reactive membrane includes a porous inorganic substrate having exposed surfaces and at least one carbon layer, which is modified to present active sites, deposited on the exposed surfaces. The active sites include metal species which are at least partially deoxygenated and are chemically bonded to the carbon layer. Methods of forming the reactive membrane and of removing impurities from a gas with the membrane are also provided.

U.S. Pat. No. 5,643,684 to Tsubouchi et al. discloses an unwoven metal fabric suitable for use as a battery electrode, a catalyst or a filter, and a method of manufacturing such fabric. An unwoven carbon fabric made up of carbon fibers bound together by a resin is heated to carbonize the binder resin and thus to impart electrical conductivity to the resin, and at the same time finely roughen the surfaces of the carbon fibers and the resin. A plating layer is directly formed on the unwoven carbon fabric thus formed by electroplating. Then, the unwoven carbon fabric is removed by roasting to provide an aggregate of metal fibers joined together and having their voids communicating with one another.

U.S. Pat. No. 5,665,479 to Vandamme et al. discloses a pressure resistant sintered nonwoven multilayer metal fiber web is particularly useful for high pressure filtration applications (e.g., polymer filtration). The web has a porosity of between 50% and 74%, a weight of between 750 and 1600 g/m², and a fiber diameter in each successive layer of between 1.2 to 2 times less than the fiber diameter in the previous layer. The web may be covered with an outer permeable layer at one, or both, of its planar sides.

U.S. Pat. No. 5,800,706 to Fischer discloses that the general area of this invention relates to porous materials made from nanofiber packed beds. More particularly, the invention relates to altering the porosity or packing structure of a nanofiber packed bed structure by blending nanofibers with scaffold particulates having larger dimensions. For example, adding large diameter fibers to a nanotube packed bed to serve as a scaffolding to hold the smaller nanofibers apart and prevent the nanofiber bed structure from collapsing. This increases the average pore size of the mass by changing the pore size distribution and alters the packing structure of the packed bed. The increase in average pore size is caused by the creation of larger channels which improves the flow of liquids or gasses through these materials.

U.S. Pat. No. 5,851,647 to Foster discloses a glass and metal fiber material that includes a web of nonwoven metal fibers and glass. The metal fibers of the web are joined by bubbles of glass to other metal fibers of the web. The nonwoven metal fibers can be the same or different lengths and do not need to be sintered. The material is flexible and capable of withstanding very high temperatures. Spaces or voids between metal fibers allow embodiments of the material to be porous. However, the voids can be completely or partially filled to alter the porosity of the material. An exemplary method of making the glass and metal fiber material in accordance with the invention includes the steps of juxtaposing metal fibers with glass fibers and heating at least the glass fibers to cause them to melt. The melting glass envelops part or all of the metal fibers. When the glass cools, at least some of the metal fibers are bound to other metal fibers by the glass. Both the metal and glass fibers can be dispersed in a liquid prior to being mixed together; and a bonding aid can be added to mixture prior to the heating step to temporarily provide stability to the web to permit processing.

U.S. Pat. No. 5,858,200 to Takahashi et al. discloses a method of manufacturing a metallic fiber from a convergent extended wire, which is formed by a metallic fiber and a matrix member which is formed of a metallic material and whose dissolvability is higher than the dissolvability of the metallic fiber. The matrix member is continuously dissolved and removed by an electrolytic processing in a plurality of electrolytic tanks which are arranged in the conveying direction of the convergent extended wire. The convergent extended wire is passed through electrolytes in the plurality of electrolytic tanks, which are arranged in the shape of a gentle convex arch at the vertical direction upper side which includes the conveying passage of the convergent extended wire. The convergent extended wire is passed above a plurality of feeding devices which are provided at the outer sides of the electrolytes and which are disposed in the same arch-shape so as to correspond to the electrolytic tanks. In each of the plurality of electrolytic tanks, the metallic fiber is maintained in one of a cathode reduction area and a passivation area, or alternatively, anode current is maintained at a predetermined potential which is closer to 0, and the matrix member is anode-electrolyzed. At this time, a method of manufacturing the twine of metallic fibers, further including the step of intertwining the convergent extended member in the unit of two to four before the electrolytic processing, while the convergent extended member is formed by a forming device in a spiral shape whose diameter is larger than the diameter of a closely-intertwined twine.

U.S. Pat. No. 5,863,311 to Nagai et al. discloses a particulate trap for a diesel engine use which is less likely to vibrate or deform under exhaust pressures and achieves good results in all of the particulate trapping properties, pressure drop, durability and regenerating properties. This trap has a filter element made of plurality of flat or cylindrical filters. Longitudinally extending exhaust incoming and outgoing spaces are defined alternately between the adjacent filters by alternately closing the inlet and outlet ends of the spaces between the adjacent filters. Gas permeable reinforcing members are inserted in the exhaust outgoing spaces to prevent the filter from being deformed due to the difference between the pressure upstream and downstream of each filter produced when exhausts pass through the filters. Similar gas permeable reinforcing members may also be inserted in the exhaust incoming spaces or at both ends of the filter element to more positively prevent vibration of the filters.

Therefore, it is an object of the present invention to provide an improved fluid separating device that overcomes the problems of the prior art and provides a significant advancement to the fluid separating art.

Another object of this invention is to provide an improved fluid separating device that is capable of separating a second fluid from a first fluid.

Another object of this invention is to provide an improved fluid separating device that is capable of separating a gas fluid from a liquid fluid.

Another object of this invention is to provide an improved fluid separating device that is capable of separating oxygen from water vapor.

Another object of this invention is to provide an improved fluid separating device that is capable of operating under high pressure.

Another object of this invention is to provide an improved fluid separating device that is capable of operating at high temperature.

Another object of this invention is to provide an improved fluid separating device that is capable of operating in a corrosive environment.

Another object of this invention is to provide an improved fluid separating device that is capable of reliable operation with little maintenance.

The foregoing has outlined some of the more pertinent objects of the present invention.

These objects should be construed as being merely illustrative of some of the more prominent features and applications of the invention. Many other beneficial results can be obtained by applying the disclosed invention in a different manner or modifying the invention within the scope of the invention. Accordingly other objects in a full understanding of the invention may be had by referring to the summary of the invention and the detailed description describing the preferred embodiment of the invention.

### SUMMARY OF THE INVENTION

A specific embodiment of the present invention is shown in the attached drawings. For the purpose of summarizing the invention, an improved filter and method of making is disclosed for filtering a second fluid from a first. The improved filter comprises a first layer of filter media comprising a sintered matrix of first fibers. A second layer of filter membrane comprises a matrix of second fibers. A third layer of filter media comprises a sintered matrix of third fibers. The first, second and third layers are formed into a lamination with the second layer being interposed between the first and third layers. The second layer has a pore size substantially less than the pore size of the first and third layers for enabling the second fluid to pass through the second layer and for inhibiting the first fluid from passing through the second layer for separating the second fluid from the first fluid.

In a more specific embodiment of the invention, the first fluid is a liquid and the second fluid is a gas. Preferably, each of the second fibers has a diameter substantially less than a diameter of the first and third fibers for enabling the second fluid to pass through the second layer and for inhibiting the first fluid from passing through the second layer.

In one example of the invention, the first layer of filter media comprises a matrix formed from a multiplicity of first major metallic fibers mixed with a multiplicity of first minor metallic fibers.

The second layer of the improved filter includes second fibers having a diameter substantially less than a diameter of the first and the third fibers. The second layer may comprise a matrix formed from a multiplicity of second major metallic fibers mixed with a multiplicity of second minor metallic fibers. In one example of the invention, each of the second fibers has a hydrophilic surface.

In one example of the invention, the third layer of filter media comprises a matrix formed from a multiplicity of third major metallic fibers mixed with a multiplicity of third minor metallic fibers.

The invention is also incorporated into the method of making an improved filter for filtering a second fluid from a first fluid comprising the steps of depositing a multiplicity of first fibers for forming a first layer of filter media, depositing a multiplicity of second fibers for forming a second layer of filter membrane and depositing a multiplicity of third fibers for forming a third layer of filter media. A lamination is formed of the first, second and third layers with the second layer being interposed between the first and third layers. The lamination is sintered for enabling the first and third layer to provide mechanical strength for the second layer with the second layer permitting the second fluid to pass through said second layer and with the second layer inhibiting the first fluid from passing through said second layer.

The foregoing has outlined rather broadly the more pertinent and important features of the present invention in order that the detailed description that follows may be better understood so that the present contribution to the art can be more fully appreciated. Additional features of the invention will be described hereinafter which form the subject matter of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention.

### BRIEF DESCRIPTION OF THE DRAWINGS

For a fuller understanding of the nature and objects of the invention, reference should be made to the following detailed description taken in connection with the accompanying drawings in which:

FIG. 1 is a block diagram illustrating the method of forming the improved fluid separating device of the present invention;

FIG. 2 is an isometric view of a set of first major and minor wires arranged in a first large strand;

FIG. 2A is an end view of FIG. 2;

FIG. 3 is an isometric view of a plurality of first large strands of first major and minor wires of FIG. 2 located within a first cladding;

FIG. 3A is an end view of FIG. 3;

FIG. 4 is an isometric view of the first cladding of FIG. 3 after a wire drawing process;

FIG. 4A is an end view of FIG. 4;

FIG. 5 is an isometric view of first major and minor fibers after the removal of the first cladding of FIG. 4;

FIG. 6 is an isometric view of a set of second major and minor wires arranged in a second small strand;

FIG. 6A is an end view of FIG. 6;

FIG. 7 is an isometric view of a plurality of second small strands of second major and minor wires of FIG. 6 located within a second cladding;

FIG. 7A is an end view of FIG. 7;

FIG. 8 is an isometric view of the second cladding of FIG. 7 after a wire drawing process;

FIG. 8A is a

FIG. 9 is an isometric view of second major and minor fibers after the removal of the second cladding of FIG. 8;

FIG. 10 is an isometric view of a first web formed from the first major and minor fibers of FIG. 5;

FIG. 11 is an isometric view of a second web formed from the second major and minor fibers of FIG. 9;

FIG. 12 is an isometric view of a lamination formed from the first and second Uwebs of FIGS. 10 and 11;

FIG. 13 is an isometric view illustrating the sintering of the lamination of FIG. 12 to create the membrane of the present invention;

FIG. 14 is a side sectional view illustrating the rolling of the membrane of FIG. 13;

FIG. 15 is a side sectional view illustrating the passivation of the membrane of FIG. 14;

FIG. 16 is a plan view of the passivated membrane of FIG. 15 mounted within a frame;

FIG. 17 is a side view of FIG. 16;

FIG. 18 is an enlarged view along line 18-18 in FIG. 16; and

FIG. 19 is a photomicrogram of a welded seam shown in FIG. 18.

Similar reference characters refer to similar parts throughout the several Figures of the drawings.

### DETAILED DISCUSSION

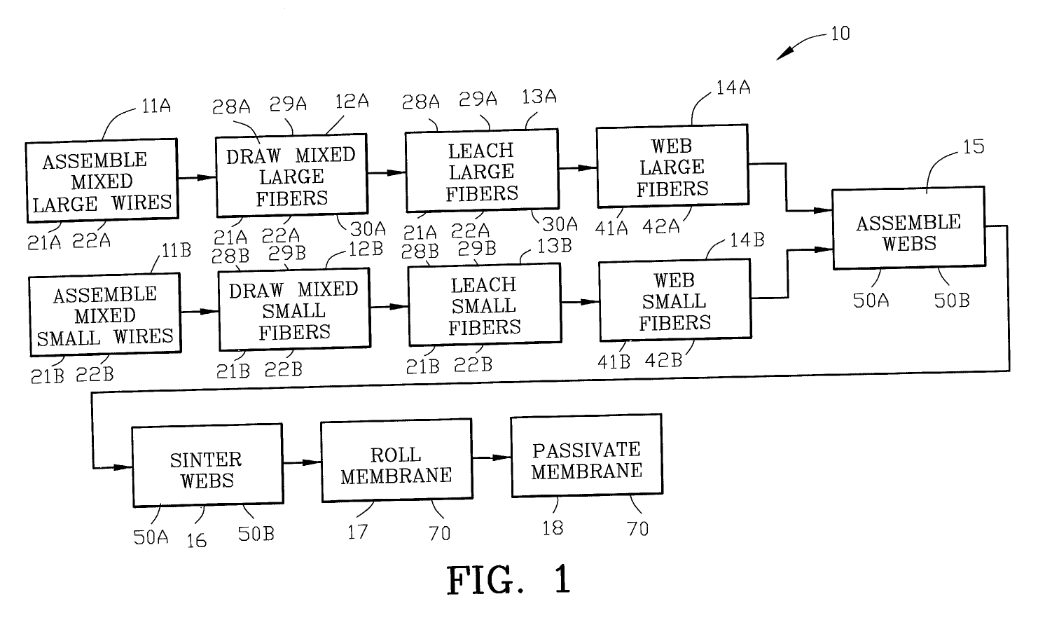

FIG. 1 is a block diagram illustrating the process 10 of forming the improved fluid separating device of the present invention. The process 10 of FIG. 1 comprises the process step of assembling a first array 20A of large mixed wires.

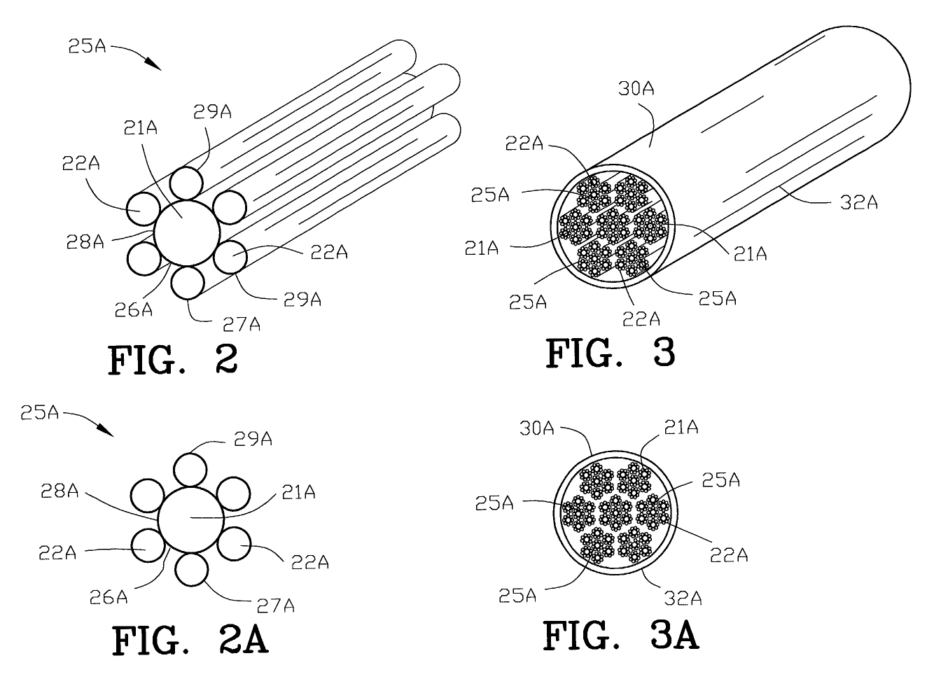

FIG. 2 is an isometric view of a first major wire 21A and a plurality of first minor wires 22A arranged in a first large strand 25A of mixed wires referred to in FIG. 1. FIG. 2A is an enlarged end view of FIG. 2. The first large strand 25A of mixed wires comprises a first major wire 21A plurality of first minor wires 22A with the first major wire 21A having a larger diameter than the first minor wire 22A. In this example of the invention, the first large strand 25A of mixed wires comprises a central first major wire 21A and six first minor wires 22A.

The central first major wire 21A has a major diameter 26A twice as large as a minor diameter 27A of the minor wire 22A. In this example of the invention, the first major wire 21A and the plurality of first minor wires 22A are stainless steel wires but it should be understood that various types of first major and minor wires 21A and 22A may be used in the improved process 10.

The first major wire 21A includes a coating material 28A located on the major diameter 28A of the central first major wire 21A. Similarly, each of the plurality of first minor wires 22A includes a coating material 29A located on the minor diameter 27A of the minor wire 22A. In this example of the invention, the coating materials 28A and 29A are copper coatings but it should be understood that various types of coating materials may be used in the improved process 10.

The process of applying the coating materials 28A and 29A to the first major and minor wires 21 A and 22A may be accomplished in various ways. One preferred process of applying the coating materials 28A and 29A to the first major and minor wires 21A and 22A is an electroplating process. Preferably, the coating materials 28A and 29A represent approximately five percent (5%) by weight of the combined weight of the first major and minor wires 21A and 22A and the coating materials 28A and 29A.

FIG. 3 is an isometric view of the first array 20A of a plurality of the first large strands 25A of first major and minor wires 21A and 22A of FIG. 2 located within a first cladding 30A. The first cladding 30A defines an outer diameter 32A of the first cladding 30A. Preferably, 150 to 1200 first large strands 25A of the first major and minor wires 21A and 22A are formed into the first array 20A within the first cladding 30A.

FIG. 3A is an end view of FIG. 3 illustrating the first cladding 30A as a preformed tube for cladding the first array 20A of a plurality of the first large strands 25A of first major and minor wires 21A and 22A. In this example, the first cladding 30A is carbon steel. In the alternative, the first cladding 30A may be a continuous tube continuously formed about the first array 20A of a plurality of the first large strands 25A of first major and minor wires 21A and 22A. However, the first cladding 30A may be made from any suitable material.

FIG. 1 illustrates the process step 12A of drawing the first cladding 30A. The process step 12A of drawing the first cladding 30A provides several effects. Firstly, the process step 12A reduces an outer diameter 32A of the first cladding 30A. Secondly, the process step 12A reduces the corresponding outer diameters 26A and 27A of each of the first major and minor wires 21A and 22A and transforms the first major and minor wires 21A and 22A into first major and minor fibers. Thirdly, the process step 12A causes the coating materials 28A and 29A on the first major and minor wires 21A and 22A to diffusion weld with the coating materials 28A and 29A on adjacent first major and minor wires 21A and 22A.

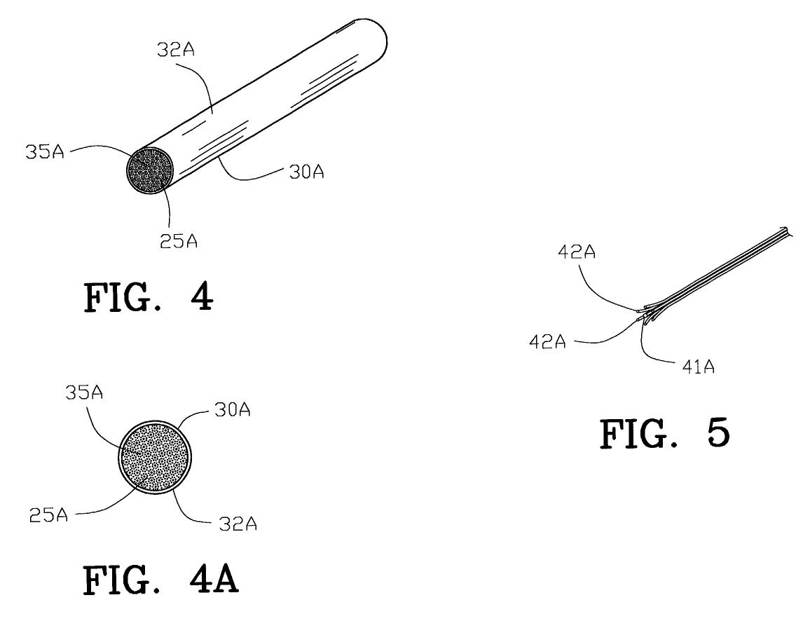

FIG. 4 is an isometric view of the first cladding 30A of FIG. 3 after process step 12A of drawing the first cladding 30A. FIG. 4A is an end view of FIG. 4. The diffusion welding of the coating materials 28A and 29A forms a unitary coating material 35A extending throughout the interior of the cladding 30A. The first array 20A of first major and minor wires 21A and 22A are contained within the unitary coating material 35A extending throughout the interior of the first cladding 30A.

FIG. 1 illustrates the process step 13A of removing the first cladding 30A and the unitary coating material 35A. In the preferred form of the process, the step 13A of removing the first cladding 30A comprises mechanically removing the first cladding 30A. In the alternative, the first cladding 30A may be chemically removed from the first major and minor wires 21A and 22A. The first cladding 30A may be chemically removed from the first major and minor wires 21A and 22A prior to or simultaneously with the removal of unitary coating material 35A.

FIG. 5 is an isometric view of a first array 40A of first major and minor fibers 41A and 42A after the removal of the first cladding 30A and after the removal of the unitary coating material 35A. Preferably, the unitary coating material 35A is chemically removed from the first major and minor wires 21A and 22A by an acid leaching process for dissolving the unitary coating material 35A to provide the first array 40A of first major and minor fibers 41A and 42A.

One example of the process step 13A includes an acid leaching process. In one example of the invention, the unitary coating material 35A is a unitary copper material 35A with the first major and minor fibers 41A and 42A being stainless steel fibers. The unitary copper material 35A containing the first major and minor stainless steel fibers 41A and 42A is immersed into a solution of 8% to 15% H2SO4 and 0.1% to 1.0% H2O2 for dissolving the unitary copper material 35A without dissolving the first major and minor stainless steel fibers 41A and 42A. The 0.1% to 1.0% H2O2 functions as an oxidizing agent to inhibit leaching of the first major and minor stainless steel fibers 41A and 42A by the H2SO4. Preferably, the 0.5% to 3.0% H2O2 is stabilized from decaying in the presence of copper such as PC circuit board grade H2O2. It should be appreciated that other oxidizing agents may be used with the present process such as sodium stanate or sodium benzoate or the like.

The above acid leaching process 13A is governed by the reaction illustrated in equation

Cu+H2O2+H2SO4→CuSO4+2H2O

The initial concentration of the H2SO4 is 11.0% at a concentration of 20.0 grams per liter of Cu+2 as CuSO4 at a temperature of 80° F. to 120° F. The concentration is maintained between 8.0% to 11.0% H2SO4 and 20.0 to 70.0 grams per liter of Cu+2 as CuSO4.

The dissolving of the unitary copper material 35A in the presence of the H2O₂ dissolves the unitary copper material 35A without dissolving the first major and minor stainless steel fibers 41A and 42A. After the unitary copper material 35A is dissolved, the first major and minor stainless steel fibers 41A and 42A are passed to a rinsing process.

The removal process 13A includes rinsing the first major and minor stainless steel fibers 41A and 42A in a rinse solution comprising H2O having a pH of 2.0 to 3.0 with the pH being adjusted with H2SO4. Maintaining the pH of the rinsing solution between a pH of 2.0 to 3.0 inhibits the formation of Fe[OH]2. The first major and minor stainless steel fibers 41A and 42A may be cut into short length fibers in the order of 1.0 cm either before or after the removal process 13A.

FIG. 1 illustrates the process step 14A of forming a first web 51A from the first major and minor fibers 41A and 42A. The process step 14A includes opening, separating and randomly orienting the first major and minor fibers 41A and 42A. The first major and minor fibers 41A and 42A are distrbuted by an air flow to settle onto a horizontal conveyor to provide a uniform first web 51A of first major and minor fibers 41A and 42A.

FIG. 1 illustrates the process step 11B of assembling a second array 20B of small mixed wires. The small mixed wires of second array 20B are substantially smaller than the large mixed wires of the first array 20A.

FIG. 6 is an isometric view of a second major wire 21B and a plurality of second minor wires 22B arranged in a second small strand 25B of mixed wires referred to in FIG. 1. FIG. 6A is an enlarged end view of FIG. 6. The second small strand 25B of mixed wires comprises a second major wire 21B and a plurality of second minor wires 22B with the second major wire 21B having a larger diameter than the second minor wire 22B. In this example of the invention, the second small strand 25B of mixed wires comprises a central second major wire 21B and six second minor wires 22B.

The central second major wire 21B has a major diameter 26B twice as large as a minor diameter 27B of the minor wire 22B. In this example of the invention, the second major wire 21B and the plurality of second minor wires 22B are stainless steel wires but it should be understood that various types of second major and minor wires 21B and 22B may be used in the improved process 10.

The second major wire 21B includes a coating material 28B located on the major diameter 28B of the central second major wire 21B. Similarly, each of the plurality of second minor wires 22B includes a coating material 29B located on the minor diameter 27B of the minor wire 22B. In this example of the invention, the coating materials 28B and 29B are copper coatings but it should be understood that various types of coating materials may be used in the improved process 10.

The process of applying the coating materials 28B and 29B to the second major and minor wires 21B and 22B may be accomplished in various ways. One preferred process of applying the coating materials 28B and 29B to the second major and minor wires 21B and 22B is an electroplating process. Preferably, the coating materials 28B and 29B represent approximately five percent (5%) by weight of the combined weight of the second major and minor wires 21B and 22B and the coating materials 28B and 29B.

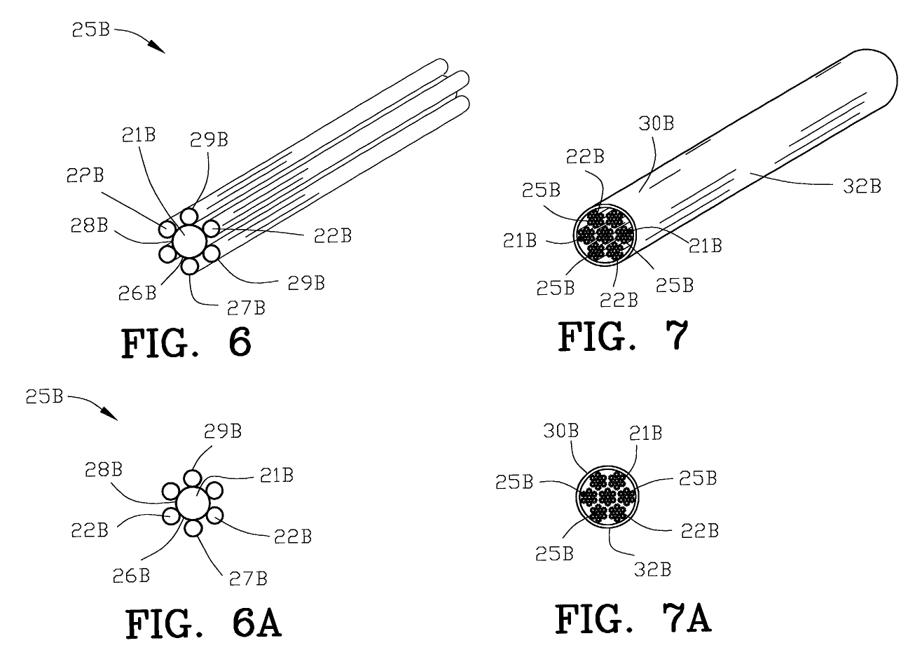

FIG. 7 is an isometric view of the second array 20B of a plurality of the second small strands 25B of second major and minor wires 21B and 22B of FIG. 6 located within a second cladding 30B. The second cladding 30B defines an outer diameter 32B of the second cladding 30B. Preferably, 150 to 1200 second small strands 25B of the second major and minor wires 21B and 22B are formed into the second array 20B within the second cladding 30B.

FIG. 7A is an end view of FIG. 7 illustrating the second cladding 30B as a preformed tube for cladding the second array 20B of a plurality of the second small strands 25B of second major and minor wires 21B and 22B. In this example, the second cladding 30B is carbon steel. In the alternative, the second cladding 30B may be a continuous tube continuously formed about the second array 20B of a plurality of the second small strands 25B of second major and minor wires 21B and 22B. However, the second cladding 30B may be made from any suitable material.

FIG. 1 illustrates the process step 12B of drawing the second cladding 30B. The process step 12B of drawing the second cladding 30B provides several effects. Firstly, the process step 12B reduces an outer diameter 32B of the second cladding 30B. Secondly, the process step 12B reduces the corresponding outer diameters 26B and 27B of each of the second major and minor wires 21B and 22B and transforms the second major and minor wires 21B and 22B into second major and minor fibers. Thirdly, the process step 12B causes the coating materials 28B and 29B on the second major and minor wires 21B and 22B to diffusion weld with the coating materials 28B and 29B on adjacent second major and minor wires 21B and 22B.

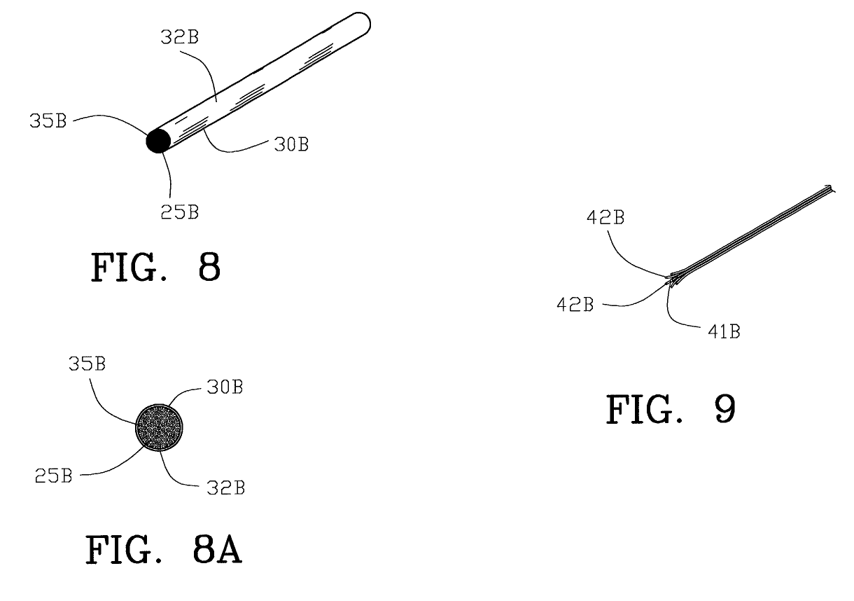

FIG. 8 is an isometric view of the second cladding 30B of FIG. 7 after process step 12B of drawing the second cladding 30B. FIG. 8A is an end view of FIG. 8. The diffusion welding of the coating materials 28B and 29B forms a unitary coating material 35B extending throughout the interior of the second cladding 30B. The second array 20B of second major and minor wires 21B and 22B are contained within the unitary coating material 35B extending throughout the interior of the second cladding 30B.

FIG. 1 illustrates the process step 13B of removing the second cladding 30B and the unitary coating material 35B. In the preferred form of the process, the step 13B of removing the second cladding 30B comprises mechanically removing the second cladding 30B. In the alternative, the second cladding 30B may be chemically removed from the second major and minor wires 21B and 22B. The second cladding 30B may be chemically removed from the second major and minor wires 21B and 22B prior to or simultaneously with the removal of i unitary coating material 35B.

FIG. 9 is an isometric view of a second array 40B of second major and minor fibers 41B and 42B after the removal of the second cladding 30B an after the removal of the unitary coating material 35B. Preferably, the unitary coating material 35B is chemically removed from the second major and minor wires 21B and 22B by an acid leaching process for dissolving the unitary coating material 35B to provide the second array 40B of second major and minor fibers 41B and 42B. One example of the process step 13B includes an acid leaching process as heretofore described.

FIG. 1 illustrates the process step 14B of forming a second web 51B from the second major and minor fibers 41B and 42B. The process step 14B includes opening, separating and randomly orienting the second major and minor fibers 41B and 42B. The second major and minor fibers 41B and 42B are distributed by an air flow to settle onto a horizontal conveyor to provide a uniform second web 51B of second major and minor fibers 41B and 42B.

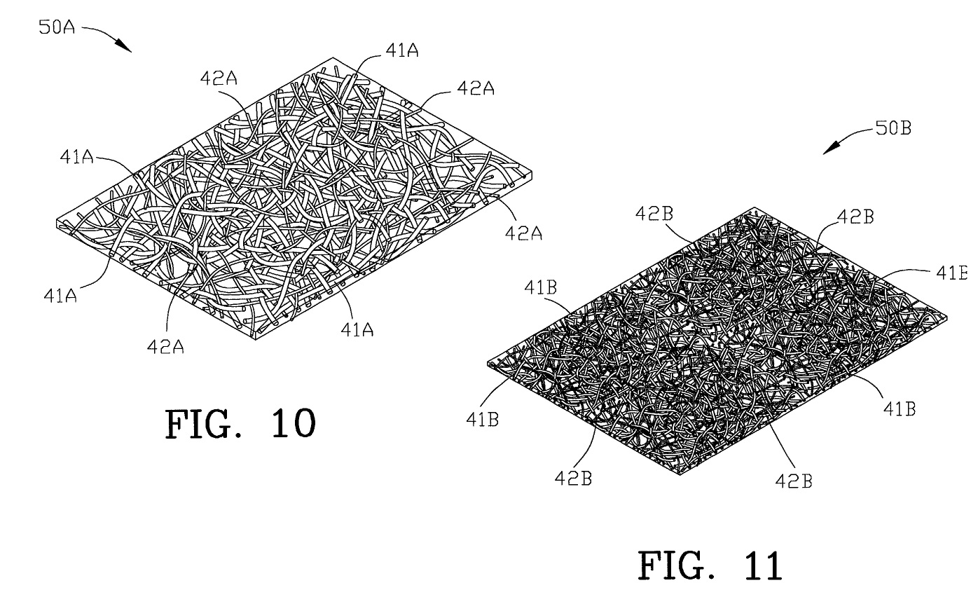

FIG. 10 is an isometric view of the first web 50A formed from the first major and minor fibers 41A and 42A. The first web 50A is formed into a substantially uniform sheet of randomly oriented first major and minor fibers 41A and 42A. The first major fibers 41A are randomly oriented within the first web 50A with the first minor fibers 42A being randomly oriented within the first web 50A and interposed between the randomly oriented first major fibers 41A.

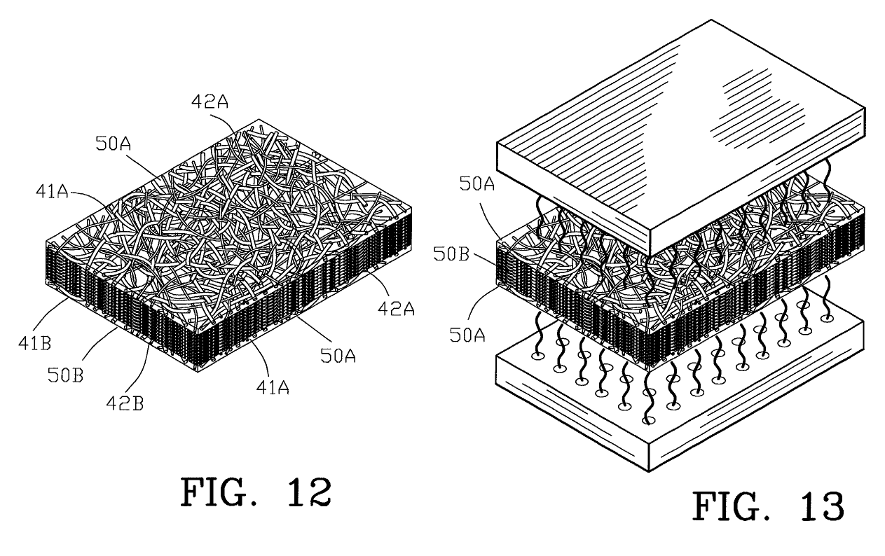

FIG. 11 is an isometric view of the second web 50B formed from the second major and minor fibers 41B and 42B. The second web 50B is formed into a substantially uniform sheet of randomly oriented second major and minor fibers 41B and 42B. The second major fibers 41B are randomly oriented within the second web 50B with the second minor fibers 42B being randomly oriented within the second web 50B and interposed between the randomly oriented second major fibers 41B.

The first web 50A of FIG. 10 is formed from the first major and minor fibers 41A and 42A. Preferably, the first major fibers 41A have a diameter of 20 microns whereas the first minor fibers 42A have a diameter of 10 microns. The mixture of the first major and minor fibers 41A and 42A provides a moderate pour size as illustrated in FIG. 10. Upon final sintering all of the first web 50A, the first web 50A provides high strength and stability as will be described in more detail hereinafter.

The second web 50B of FIG. 11 is formed from the second major and minor fibers 41B and 42B. Preferably, the second major fibers 41B have a diameter of 4 microns whereas the second minor fibers 42B have a diameter of 2 microns. The mixture of the second major and minor fibers 41B and 42B provides a very small pore size as illustrated in FIG. 11. Upon final sintering of the second web 50B the second web 50B provides ultra-filtration as will be described in more detail hereinafter.

FIG. 1 illustrates the process step 15 of forming a lamination 60 from the first and second webs 50A and 50B. The lamination 60 is formed from a plurality of the first and second webs 50A and 50B. The number and arrangement of the plurality of the first and second webs 50A and 50B use to form the lamination 60 is dependent upon the desired characteristics of the membrane to be formed from the lamination 60.

FIG. 12 is an isometric view of the lamination 60 formed from the first and second webs 50A and 50B of FIGS. 10 and 11. In this embodiment of the invention, the lamination 60 is formed from a plurality of second inner webs 50B interposed between the first outer webs 50A. The first outer webs 50A provides a high strength and stability to of the lamination 60. The second inner webs 50B provide an ultra-filtration membrane 70.

FIG. 1 illustrates the process step 16 of sintering the lamination shown in FIG. 12. Preferably, the lamination 60 is weighted and is sintered within a specialized atmosphere. FIG. 13 is an isometric view illustrating the sintering of the lamination 60 of FIG. 12 to form the membrane 70. In one example of the invention, the lamination 60 is sintered within a reducing atmosphere such as a hydrogen atmosphere as symbolized in FIG. 13. The sintered lamination 60 is transformed into the membrane 70 of the present invention.

FIG. 1 illustrates the process step 17 of rolling the membrane 70 shown in FIG. 13. The membrane 70 is rolled to control the thickness of the membrane 70.

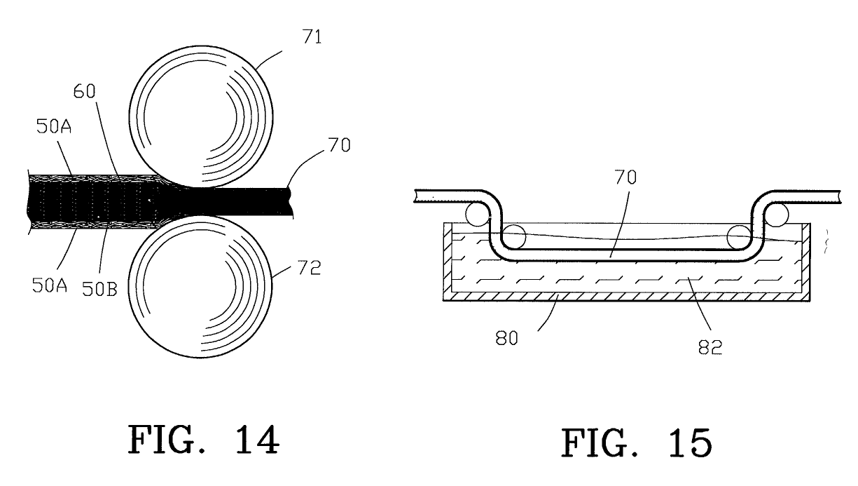

FIG. 14 is a side sectional view illustrating the rolling of the membrane 70 of FIG. 13. The membrane 70 is passed between plural rolls 71 and 72 to control the thickness of the membrane 70.

FIG. 1 illustrates the process step 18 of passivating the membrane 70 shown in FIG. 14. The membrane 70 is passivated to enhance the hydrophilic properties of membrane 70.

FIG. 15 is a side sectional view illustrating the passivation the membrane of FIG. 14. The membrane 70 is immersed within a bath 80 of a liquid 82 for passivating the surfaces of the first major and minor fibers 41A and 42A and the second major and minor fibers 41A and 42A. In one example of the invention, citric acid has been used to passivate stainless steel fibers.

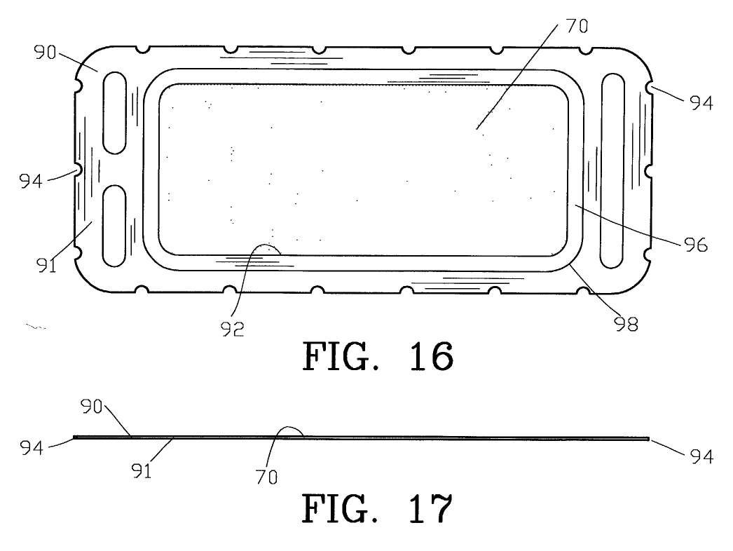

FIGS. 16 and 17 are plan and side views of the membrane 70 of FIG. 15 mounted within a frame 90. In this example of the invention, the frame 90 comprises an outer periphery 91 defining a central aperture 92. A plurality of mounting holes 94 are provided for mounting the frame 90. The frame 90 includes a recess 96 extending about the central aperture 92 for receiving a portion of the membrane 70.

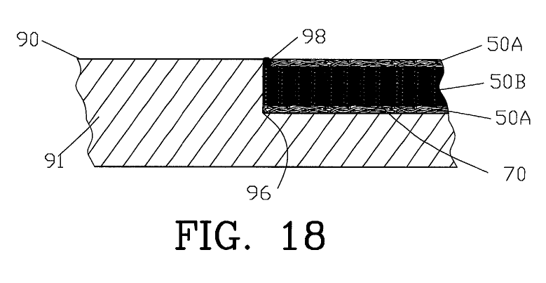

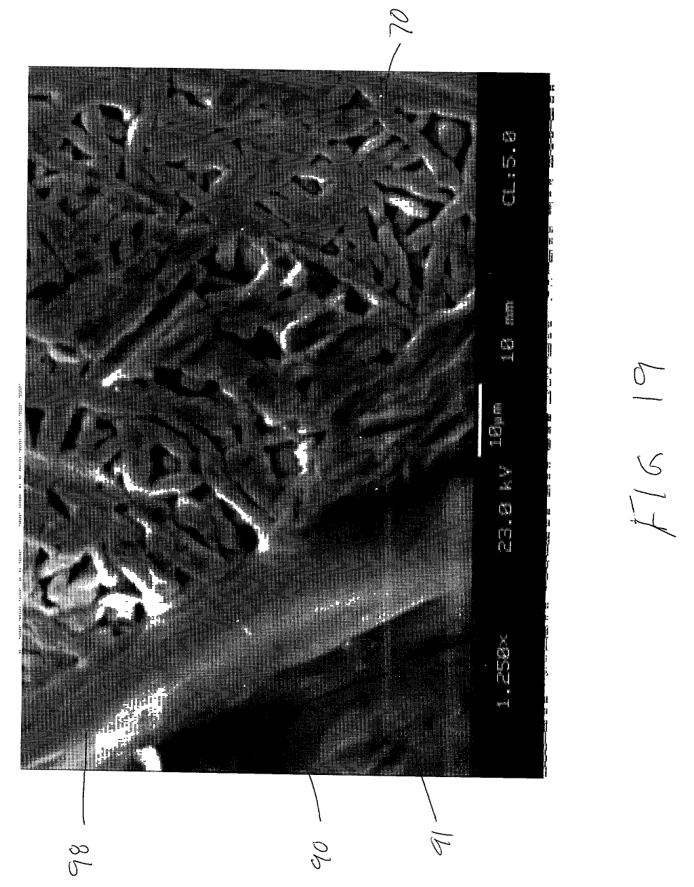

FIG. 18 is an enlarged view along line 18-18 in FIG. 16 illustrating the membrane 70 being located within the recess 96. The membrane 70 is shown being welded to the frame 90 by a welding bead 98. Preferably, the welding of the membrane 70 to the frame 90 is accomplished by a laser welding process.

The first web 51 comprising the first major and minor fibers 41A and 42A provide a greater mass for enabling the membrane 70 to be welded to the frame 90. Furthermore, the first web 51 comprising the first major and minor fibers 41A and 42A provide mechanical strength to the membrane 70. Membranes 70 supported by frames 90 having a central aperture 92 of 3 inches by 8 inches have used with liquid pressures of 25 pound per square inch in a gas-liquid separation.

FIG. 19 is a photomicrogram of the welded seam 98 shown in FIG. 18. The first major and minor fibers 41A and 42A of the first web 51 provide the mass sufficient to laser weld the membrane 70 to the frame 90. The welding process does not interfere with the separation abilities of the second web 52.

### EXAMPLE I

2 micron and 4 micron fiber were uniformly distributed in three dimensions to obtain desired properties. The web layers having the same basis weight, 190 gm/m (5.5 oz/yd²), were stacked up to ten layers high. 20 micron and 10 micron fiber layers were uniformly distributed in three dimensions on the external surfaces of the above stack of web layers. Several of these building block combinations were fabricated, sintered under load, then compressed by rolling for filtration property analysis as a function of formulation and processing variables. The objective is to establish a stable processible range, where the optimal porosity, bubble point and thickness are reproducible.

The optimized membrane formulation was laser welded into 31 6L stainless steel electroetched frames, 0.0508 cm thick for mounting in electrolysis cells. Bubble point testing was conducted after welding to ensure leak tightness. To ensure hydrophilic properties, the finished membrane unit was surface treated using a proprietary process.

The filtration properties of these membranes are summarized in TABLE I. Media flow resistance (MFR), the inverse of permeability, is the pressure drop across the membrane created by an air velocity of 20 cm/sec (see ISO 4022). Minimum bubble point pressure (MBP), (e.g., the first bubble stream) is correlated to the largest pore size [4,5]. The 0.0508 cm thick membrane was chosen as the optimum membrane.

TABLE I
Membrane Properties as a function of Thickness

| Thickness (cm) | MBP (MPa) | MFR (MPa) | Porosity (%) |
|---|---|---|---|
| 0.100 | 0.0055 | 0.0017 | 73.0 |
| 0.076 | 0.0070 | 0.0019 | 63.0 |
| 0.051 | 0.0093 | 0.0046 | 45.0 |
| 0.025 | 0.0013 | 0.0470 | 9.4 |
| 0.023 | 0.0442 | 0.1380 | — |

316L stainless steel fibrous media, containing a designed distribution of 2 micron and 4 micron fiber was processed into a thin hydrophilic membrane capable of withstanding bubble point pressures greater than 0.01035 MPa (1.5 psi). Media flow resistance, the inverse of permeability, was more than sufficient to allow oxygen separation from water in on board oxygen generators.

### EXAMPLE II

As-processed membrane is hydrophobic; water beads on the surface of standard 316L SS filter membrane. In order to convert the media to one of a hydrophilic nature it was subjected to passivation in 10% citric acid with an ionic surfactant at 180° F. for 30 minutes. The material was then rinsed with distilled water and, dried in an oven at 150° C. for 16 hours. After this treatment the material readily absorbs water. It is believed that the oxide on the surface of the media changes to one more polar which allows for attraction of water. Water absorption on membranes air dried was intermittent. Consistent results were only achieved with oven drying. It is believed that the oxide on the surface of the media changes to one more polar which allows for attraction of water.

The present invention provides an improved fluid separating device having a first, second and third layer being formed into a lamination. The second layer is interposed between the first and the third layer to provide mechanical strength for the second layer. The second layer has a pore size substantially less than a pore size of the first and third layers. The second layer enables the second fluid to pass through the second layer and inhibits the first fluid from passing through the second layer for separating the second fluid from the first fluid.

The first, second and third layers may have mixed diameter of metallic fibers. The mixed diameter fibers have many processing and operational advantages to numerous to mention. Furthermore, the mixed fibers are capable of being prepared into media by a wet preparation or a dry preparation process.

The first, second and third layers may be formed from high temperature, corrosion resistant, pressure resistant alloys. For example, any of the first, second and third layers may be formed of HR-160, FeCrAlY modified with Molybdenum, Alloy 214 for use at temperatures approaching 1200 C. In another example, the first and third layers may be formed from high temperature, corrosion resistant, pressure resistant alloys for protecting the second layer.

The first, second and third layers form a metallic membrane suitable for a wide variety of uses and applications. The metallic membrane may be used for the ultra filtration of liquids and gases. For example, the metallic membranes may be used for the filtration of gases in the construction of semiconductors as well in various other applications such as the filtration of blood and other bodily fluids. The metallic membrane may be used as a catalyst carrier or any other similar use.

The metallic membrane may be used as an electrically conductive electrode. The metallic membrane may be used as an electrode in the form of a battery plate. Furthermore, the metallic membrane may be used as an electrically conductive electrode in an oxygen generating process. The metallic membranes may be used for oxygen separation in an oxygen separator. The metallic membranes find particular application in fuel cells.

Although the aforementioned specification has been set forth with reference to making the metallic membrane from stainless steel fibers, it should be understood that the apparatus and process of the invention is suitable for use with a wide variety of metals and types of fibers. It should be understood that various other materials may be used in the present process and that the number and dimensions set forth herein are only by way of example and that one skilled in the art may vary the disclosed process based on the disclosure of the present invention.

Furthermore, although the aforementioned specification has been set forth with reference to using major wires 21A and 22A and minor wires 21B and 22B for the first and second webs 51 and 52, it should be understood that the present invention should not be limited to using mixed wires and or mixed fibers.

Although the invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. An improved fluid separating device for filtering a second fluid from a first fluid, comprising:
a first layer of filter media comprising a sintered matrix of first fibers;
a second layer of filter membrane comprising a matrix of second fibers;
a third layer of filter media comprising a sintered matrix of third fibers;
said first, second and third layers forming a lamination with said second layer being interposed between said first and third layers; and
said second layer having a pore size substantially less than a pour size of said first and third layers for enabling the second fluid to pass through said second layer and for inhibiting the first fluid from passing through said second layer for separating the second fluid from the first fluid.

2. An improved fluid separating device for filtering a second fluid from a first fluid as set forth in claim 1, wherein the first fluid is a liquid and the second fluid is a gas.

3. An improved fluid separating device for filtering a second fluid from a first fluid as set forth in claim 1, wherein each of said second fibers has a diameter substantially less than a diameter of said first and third fibers for enabling the second fluid to pass through said second layer and for inhibiting the first fluid from passing through said second layer.

4. An improved fluid separating device for filtering a second fluid from a first fluid as set forth in claim 1, wherein each of said first fibers comprise metallic fibers.

5. An improved fluid separating device for filtering a second fluid from a first fluid as set forth in claim 1, wherein said first layer of filter media comprises a matrix formed from a multiplicity of first major metallic fibers mixed with a multiplicity of first minor metallic fibers.

6. An improved fluid separating device for filtering a second fluid from a first fluid as set forth in claim 1, wherein each of said second fibers comprise a metallic fiber having a diameter substantially less than a diameter of said first and said third fibers.

7. An improved fluid separating device for filtering a second fluid from a first fluid as set forth in claim 1, wherein each of said second fibers has an active surface.

8. An improved fluid separating device for filtering a second fluid from a first fluid as set forth in claim 1, wherein each of said second fibers has an active hydrophilic surface.

9. An improved fluid separating device for filtering a second fluid from a first fluid as set forth in claim 1, wherein said second layer of filter membrane comprises a matrix formed from a multiplicity of second major metallic fibers mixed with a multiplicity of second minor metallic fibers.

10. An improved fluid separating device for filtering a second fluid from a first fluid as set forth in claim 1, wherein each of said third fibers comprise metallic fibers.

11. An improved fluid separating device for filtering a second fluid from a first fluid as set forth in claim 1, wherein said third layer of filter media comprises a matrix formed from a multiplicity of third major metallic fibers mixed with a multiplicity of third minor metallic fibers.

12. An improved fluid separating device for filtering a second fluid from a first fluid as set forth in claim 1, wherein said lamination comprises a sintered lamination of said first, second and third layers.

13. An improved fluid separating device for filtering a gas from a liquid, comprising:
a first layer of filter media comprising a sintered matrix of first metallic fibers;
said sintered matrix of first metallic fibers including first metallic fibers defining a first fiber diameter;
a second layer of filter membrane comprising a matrix of second fibers;
said matrix of second fibers including second fibers defining a second fiber diameter;
a third layer of filter media comprising a sintered matrix of third fibers;
said sintered matrix of third metallic fibers including third metallic fibers defining a third fiber diameter;
said second fiber diameter being substantially less than said first fiber diameter and said third fiber diameter providing said second layer with a pore size substantially less than a pore size of said first and third layers;
said first, second and third layers being formed into a lamination with said second layer being interposed between said first and third layers for enabling said first and third layer to provide mechanical strength for said second layer; and
said second layer enabling the gas to pass through said second layer and inhibiting the liquid from passing through said second layer.

14. An improved fluid separating device for filtering a gas from a liquid as set forth in claim 13, wherein said sintered matrix of first metallic fibers includes a multiplicity of first major metallic fibers with each of said first major metallic fibers having a first major diameter being mixed with a multiplicity of first minor metallic fibers with each of said first minor metallic fibers having a first minor diameter.

15. An improved fluid separating device for filtering a gas from a liquid as set forth in claim 13, wherein said matrix of second fibers includes a multiplicity of second major fibers with each of said second major fibers having a second major diameter being mixed with a multiplicity of second minor fibers with each of said second minor fibers having a second minor diameter.

16. An improved fluid separating device for filtering a gas from a liquid as set forth in claim 13, wherein each of said second fibers has an active surface.

17. An improved fluid separating device for filtering a gas from a liquid as set forth in claim 13, wherein each of said second fibers has an active hydrophilic surface.

18. An improved fluid separating device for filtering a gas from a liquid as set forth in claim 13, wherein said third layer of filter media comprises a matrix formed from a multiplicity of third major metallic fibers mixed with a multiplicity of third minor metallic fibers.

19. An improved fluid separating device for filtering a gas from a liquid as set forth in claim 13, wherein said first, second and third layers being formed into a lamination formed from a web of said first, second and third layers being sinter bonded to form a unitary membrane.

20. An improved fluid separating device for filtering a gas from a liquid as set forth in claim 13, wherein said first, second and third layers being formed into a lamination formed from a web of said first, second and third layers being sinter bonded to form a unitary membrane; and
said first layer being substantially identical to said third layer.

21. The method of making an improved fluid separating device for filtering a second fluid from a first fluid, comprising the steps of:
depositing a multiplicity of first fibers for forming a first layer of filter media;
depositing a multiplicity of second fibers for forming a second layer of filter membrane;
depositing a multiplicity of third fibers for forming a third layer of filter media;
forming a lamination of the first, second and third layers with the second layer being interposed between the first and third layers; and
sintering the lamination for enabling the first and third layer to provide mechanical strength for the second layer for with the second layer permitting the second fluid to pass through said second layer with the second layer inhibiting the first fluid from passing through said second layer.

22. The method of making an improved fluid separating device as set forth in claim 21, wherein the step of depositing a multiplicity of first fibers for forming a first layer of filter media includes air laying a multiplicity of first fibers onto a substrate to form a first web thereby.

23. The method of making an improved fluid separating device as set forth in claim 21, wherein the step of depositing a multiplicity of second fibers for forming a second layer of filter membrane includes air laying a multiplicity of second fibers onto a substrate to form a second web thereby.

24. The method of making an improved fluid separating device as set forth in claim 21, wherein the step of depositing a multiplicity of third fibers for forming the third layer of filter media includes air laying a multiplicity of third fibers onto a substrate to form a third web thereby.

25. The method of making an improved fluid separating device as set forth in claim 21, wherein the step forming the lamination of the first, second and third layers includes laying a multiplicity of second layers onto the first layer; and
overlaying the second layer of filter membrane t he third layer of filter media.
